(19) United States
(12) Patent Application Publication
(10) Pub. No.: US 2025/0186989 A1
(43) Pub. Date: Jun. 12, 2025

(54) METHODS AND SYSTEMS ASSOCIATED WITH REGENERATING PFAS-SELECTIVE RESINS

(71) Applicant: Scidev Energy Services, Inc., Houston, TX (US)

(72) Inventors: Quinn McLeish Smith, Oakville (CA); Sean Matthew Halpin, RANDWICK (AU); Adam Abbas Farahani, KINGS LANGLEY (AU); Matilda Eve Kearney, NEW LAMBTON (AU); Jake Angus Reardon, RANDWICK (AU)

(73) Assignee: Scidev Energy Services, Inc., Houston, TX (US)

(21) Appl. No.: 18/976,663

(22) Filed: Dec. 11, 2024

Related U.S. Application Data
(60) Provisional application No. 63/609,151, filed on Dec. 12, 2023.

(51) Int. Cl. B01J 49/57; B01J 41/07; B01J 41/12; C02F 1/42; C02F 101/36

(52) U.S. Cl. CPC B01J 49/57; B01J 41/07; B01J 41/12; C02F 1/42; C02F 2001/422; C02F 2101/36; C02F 2303/16

(57) ABSTRACT

Embodiments are directed toward systems and methods associated with PFAS-selective anion exchange resin regeneration solutions and processes for water treatment. In embodiments, a resin regeneration solution is pumped through a vessel or storage container, wherein the storage container may initially include resin saturated with PFAS. The resin regeneration solution may strip the PFAS from the resin, and may be pumped into a waste tank along with the PFAS while the resin remains in the vessel or storage container.

### BACKGROUND INFORMATION

### Field of the Disclosure

Examples of the present disclosure relate to systems and methods associated with regenerating resin. More specifically, embodiments are directed towards stripping PFAS from PFAS-selective anion exchange resins (hereafter ‘resins’) allowing for resin regeneration and reuse, wherein a regeneration process that includes treatment with a strong acid and a brine or caustic brine solutionis applied, with an optional solvent rinse.

### Background

Water treatment technologies exploit a contaminant's chemical and physical properties to immobilize, remove, or destroy the contaminant. Conventionally, water can become contaminated with PFAS, and the stability and surfactant nature of PFAS make many treatment technologies ineffective, including those that rely on contaminant volatilization (for example, air stripping, soil vapor extraction) or bioremediation (for example, biosparging, biostimulation, bioaugmentation). Even technologies such as thermal treatment and chemical oxidation may not be completely effective at treating PFAS. Because existing treatment technologies have generally shown to be inadequate, the unique chemical properties of PFAS often require new technologies or innovative combinations of existing technologies. Treatment technologies can be employed either ex situ or in situ.

One such way of removing PFAS utilize anionic resins, wherein the resin may be single-use or regenerable resins. Single-use resins are used until contaminant breakthrough occurs at a pre-established threshold, and are then removed from a vessel and disposed of by high-temperature incineration, by landfilling where permitted, or through the use of other destructive technologies. Utilizing single-use resins may require a treatment vessel to be taken offline, new resin imported and exchanged within the vessel, with the vessel then being returned to service put online. Alternatively, a multi-vessel configuration can be used in a lead-lag orientation whereby the lead vessel(s) is removed from service to remove, import and exchange the resin contained within the vessel while the lag vessel(s) is rotated into the lead position to prevent treatment disruption.

Regenerable resins are used until breakthrough but are then regenerated on-site using a regenerant solution capable of returning part of or the full ion exchange capacity to the resin. Methods to regenerable resins typically aim to completely regenerate the resins by desorbing the PFAS from the resin, leading to the resin maintaining part of to maximum capacity over time. While this process may reduce the expenditures required for replacing the resin, due to the resins maintaining part to maximum capacity, the time, infrastructure costs and safety precautions required to completely regenerate the resins may also be uneconomical and require time-intensive processes. Specifically, when these processes attempt to separate and recover the regenerated solution for further processing.

To this end, current solutions either cycle new resins into water treatment systems, or recover the regenerable resin solutions. Both solutions are costly and time-intensive.

Accordingly, needs exist for systems and methods associated with resin regeneration solutions and processes that may not maintain the resin's maximum capacity, wherein the regeneration solution is moved to a waste tank along containing the PFAS stripped from the resin for disposal or destruction.

### SUMMARY

Embodiments are directed toward systems and methods associated with resin regeneration solutions and processes for water treatment. In embodiments, a resin regeneration solution is pumped through a vessel or storage container, wherein the storage container may initially include resin saturated or partially saturated with PFAS. The resin regeneration solution may strip the PFAS from the resin, and may be pumped into a waste tank along with the PFAS while the resin remains in the vessel or storage container. The resin's maximum regenerated capacity may be reduced by up to 20% of its previous maximum capacity. The resin regeneration solution along with the PFAS within the waste tank may be held for disposal or the application of a destruction technology. This may lead to economical ways of treating water which do not recover the resin regeneration solution nor require replacing the resin between each regenerative cycle.

An optional step may be applied at this point, whereby a methanol rinse is applied to help increase the resin's regeneration capacity. This solvent waste is stored in a separate waste tank and held for disposal.

Specific embodiments may include a resin regeneration solution tank, a vessel, a waste tank, a solvent solution tank (optional), a solvent waste tank (optional), and a destruction technology (optional).

The resin regeneration solution tank may be configured to store resin regeneration solution. The resin regeneration solution may be of different chemistries and formulated to maximize PFAS removal from the resin. In embodiments, the resin regeneration solution may include brine with one or more salts at a concentration of 5-10% (w/w). Then, 2-5% of a strong base (w/w) to the brine solution. Other embodiments may include a resin regeneration solution of brine with one or more salts at 5-10% (w/w). In embodiments, the resin regeneration solution may also include a strong acid, wherein equimolar ratios of the strong acid and the strong base are used to make the 10% salt (w/w), as opposed to using a mineral salt. In these embodiments, the strong acid may be added to the water first, and then the strong base slowly added to the acid solution.

The vessel may be a storage container that is configured to store the resin. The vessel may be configured to store the resin while the resin is treating contaminated water allowing the resin the adsorb PFAS from the water. This may gradually reduce the resin's maximum capacity. After the resin becomes partially or fully saturated, without moving the resin from the vessel, regeneration cycles may commence. The resin regeneration solution may be pumped into the vessel, which may strip part or all of the PFAS from the resin. The vessel may also be configured to allow the stripped PFAS and the resin regeneration solution to be pumped out of the vessel into a storage container for processing while the resin remains within the vessel.

In embodiments, the resin may be a Weak Base Anion (WBA) resin, wherein the WBA resin has selectivity towards PFAS. The stripping of the PFAS from the resin may regenerate the resin to at least 80% of the resin's maximum capacity, such that the first regenerative process may cause the resin the have 80% maximum capacity. A second regenerative process may cause the resin to have a 64% maximum capacity, and a subsequent regenerative process may cause it to have a 51% maximum capacity. This process may continue until it is deemed that the maximum capacity of the resin is no longer efficient or effective. Accordingly, these processes for regenerating the resin may allow the resin to be used for multiple cycles, and subsequently disposed of or destroyed. To this end, embodiments are directed towards low to medium-high flow rates and PFAS concentration water treatment systems where resins can be used for multiple cycles without having to replace the resins between each cycle, providing economic benefit, yet the resins will have to be eventually replaced because of the inability of embodiments to completely return the resins to their initial maximum capacity. It is recognized that this is not likely an economically viable technology for extreme flow rates and PFAS concentration water treatment requirements.

In specific embodiments, the vessel may be air sparged and backflushed to get the resin bed as clean as possible. The resin solution may then be pumped into the vessel, and the filter vessels may be air sparged to get homogenization of the resin beads. Next, the resin regeneration solution may be run in either a co-current or counter-current flow as slowly as possible with a pump, such as 5 m/hr through bed velocity, sending the regen waste into the waste tank. This may put the resin under osmotic shock and release all held anions, wherein the anions are replaced with OH-which puts the resin in free base form. 2% strong acid may be mixed up within the bed volumes, such as two times the bed volumes within the vessel, to put the resin back in a Cl-form. The bed volumes may then be rinsed until pH stabilizes, which may require the bed volumes to be rinsed up to ten times. This volume can be reduced by using rinse water with a slightly elevated pH (around 8-8.5), and recirculating the rinse water, adjusting the pH to 8 before sending the rinse water back through the bed volumes.

The waste tank may be configured to receive the stripped PFAS, the resin regeneration solution, and the rinse water. The stripped PFAS and resin regeneration solution may then be destroyed or disposed of. This may be different than prior art solutions, wherein further processing is done to the resin regeneration solution such that the resin regeneration solution may be recovered for additional cycles and the PFAS waste further concentrated. Specifically, prior art solutions utilize resin regeneration solutions containing methanol or other organic solvents that require additional infrastructure, processing concentration steps and expenses so these solvents can be distilled and recovered in a facility complying with Class 1, Div 2 requirements to be economically effective.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts a system topology for resin regeneration and resin regeneration solution disposal, according to an embodiment.

FIG. 2 depicts a flow chart associated with resin regeneration, according to an embodiment.

FIG. 3 depicts a flow chart associated with resin regeneration, according to an embodiment.

FIG. 4 depicts a flow chart associated with resin regeneration, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art, that the specific detail need not be employed to practice the present embodiments. In other instances, well-known materials or methods have not been described in detail in order to avoid obscuring the present embodiments.

Embodiments are directed towards systems and methods associated with resin regeneration solutions and processes. In embodiments, a resin regeneration solution is pumped through a vessel or storage container, wherein the storage container may initially include resin that had previously treated contaminated water, therefore the resin may be saturated with PFAS. The resin regeneration solution may strip the PFAS from the resin, and may be pumped into a waste tank along with the PFAS, while the resin remain in the vessel or storage container. The resin's maximum regenerated capacity may be reduced by up to 20% of its previous maximum capacity. The resin regeneration solution along with the PFAS within the waste tank may be held for diposal or the application of a destruction technology.

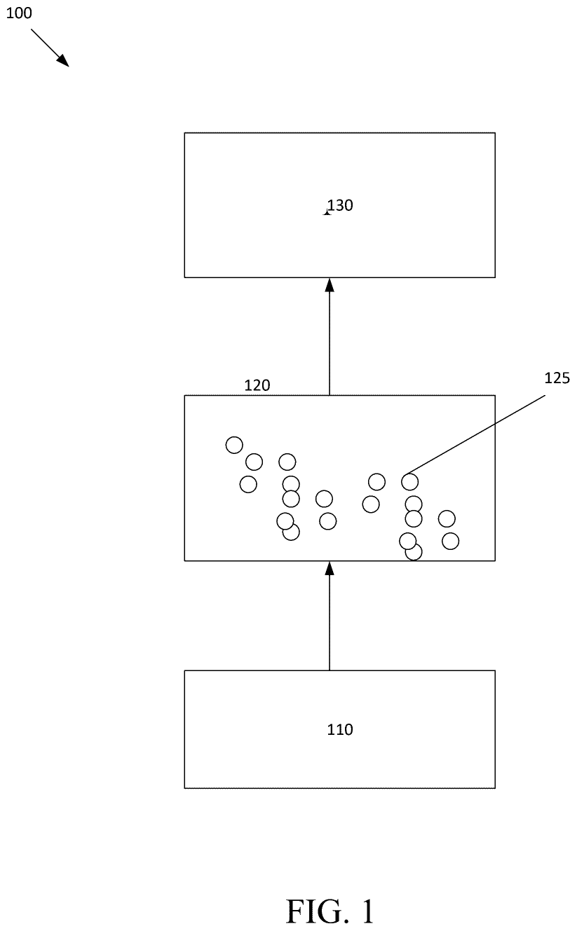

FIG. 1 depicts a system 100 for resin regeneration, according to an embodiment. System 100 may include a resin regeneration solution tank 110, a vessel 120 containing resin 125, and a waste tank 130.

The resin regeneration solution tank 110 may be a storage tank that is configured to store resin regeneration solution. The resin regeneration solution tank 110 may include an inlet configured to receive regeneration solution, and an outlet configured to output the resin regeneration solution stored within tank 110. Specifically, after a regeneration cycle, new resin regeneration solution may be positioned within tank 110, wherein the new resin regeneration solution may not have been used in any previous regeneration cycles. In specific embodiments, the resin regeneration solution may be a caustic brine and a strong acid, which is pumped from resin regeneration solution tank 110 into vessel 120 at a desired rate.

The vessel 120 containing resin 125 may include an inlet configured to receive water containing PFAS and/or resin regeneration solution from resin regeneration solution tank 110. Vessel 120 may also include an outlet configured to output water, resin regeneration solution, and/or PFAS stripped from the resin into waste tank 130. Additionally, vessel 120 may be configured to store resin 125.

In operations, water or other fluids with PFAS may be pumped through vessel 120. Due to resin 125 having a strong affinity to PFAS, resin 125 may adsorb PFAS that is being pumped through vessel 120 until resin 125 becomes saturated, otherwise approaches its maximum capacity, until a predetermined amount of fluid has been pumped through vessel 120, after a predetermined amount of time, and/or any other measurement to determine how the current capacity of the resin 125 within vessel 120. Furthermore, vessel 120 may be configured to treat the flow of fluid in situ, where water containment with PFAS can flow through vessel 120, and then subsequently treated without moving vessel 120 or the resin 125. However, in other embodiments, vessel 120 may filter contaminated water ex situ, and brought into system 100.

After the resin 125 becomes saturated with PFAS a regeneration cycle may be implemented. The regeneration cycle may be configured to reduce the saturation of resin 125 utilizing the resin regeneration solution to strip the PFAS from resin 125, wherein the resin regeneration solution is later removed from the system.

The waste tank 130 may be a container that is configured to receive the stripped PFAS, resin regeneration solution, and/or water during a regeneration cycle. Waste tank 130 may have an inlet configured to receive the fluids and an outlet. In embodiments, PFAS, resin regeneration solution, and/or water may be configured to be treated and disposed of or destroyed. When the PFAS, resin regeneration solution, and/or water is treaded, waste tank 130 may be dosed with powdered activated carbon (PAC) to bind the PFAS into a solid waste. For example, 5 g/L of PAC may be used during a disposal cycle. Alternatively, the liquid waste may be sent to a destruction technology to mineralize the PFAS compounds or a compound and/or membrane filtration used to remove PFAS and reuse the caustic solution OR the liquid may be disposed via other practical methods.

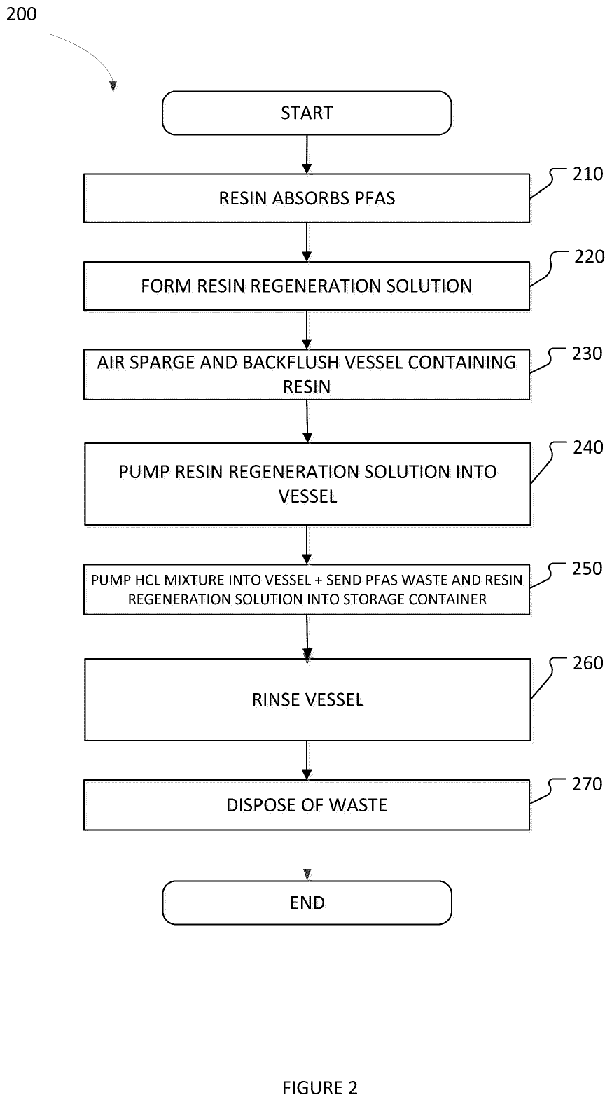

FIG. 2 depicts a method 200 for regenerating resin while stripping PFAS from the resin and disposing a resin regeneration solution, according to an embodiment. The operations of method 200 presented below are intended to be illustrative. In some embodiments, method 200 may be accomplished with one or more additional operations not described, and/or without one or more of the operations discussed. Additionally, the order in which the operations of method 200 are illustrated in FIG. 2 and described below is not intended to be limiting.

At operation 210, contaminated water may flow through a vessel including resin. Due to the resin's selectivity for PFAS, the resin may adsorb the PFAS, allowing the water to be filtered.

In embodiments, the resin may be a WBA or SBA resin which be delivered in different forms such as free base form or Cl-form. Resins in free base form tend to react only with strong acids, but for PFAS the resins may be converted into Cl-form to increase the range of PFAS selectively, which may be done with 2% strong acid solution. While the WBA may have a higher tendency to leak PFAS, they have a much higher capacity than strong base alternatives. Once the resin is loaded up to breakthrough point with PFAS, the flowing water through the vessel may stop.

At operation 220, a resin regeneration solution may be formed. The resin regeneration solution may include brine with one or more salts at a concentration of 10% (w/w). Next 2-5% of a strong base (w/w) may be added to the brine solution.

At operation 230, the vessel with the resin may be air sparge and backflushed to get the beds as clean as possible and to get homogenization of resin beads.

At operation 240, the resin regeneration solution may be pumped into the vessel in a counter-current flow as slowly as possible with a variable speed drive pump, while the regen waste (including the PFAS) is sent to the waste tank. This may put the resin under osmotic shock, and the resin may release all held anions that are replaced with OH—, which puts the resin in free base form.

At operation 250, a strong acid mixture may be pumped into the vessel, such as two bed volumes with 2% of a strong acid (w/w). The acid solution may be run in counter current flow, sending the regen waste (including the PFAS) to the waste tank OR to the head of the system for retreatment. This may put the resin into Cl-form.

At operation 260, the vessel may be rinsed in the normal flow direction until the pH of the beads stabilizes. This may require the bed volumes be rinsed up to ten times. This volume can be reduces by using rinse water with a slightly elevated pH (around 8-8.5), and recirculating the rinse water, adjusting the pH to 8 before sending the rinse water back through the bed volumes.

At operation 270, the waste tank may be dosed with PAC to bind PFAS into solid waste, such as 5 g/L of PAC for a WBA regeneration cycle. The remaining brine may be blended into a discharge tank slowly. Alternatively, the liquid waste may be sent to a destruction technology to mineralize the PFAS compounds OR a compound and/or membrane filtration applied to recycle the caustic solution OR the liquid may be disposed via other practical methods.

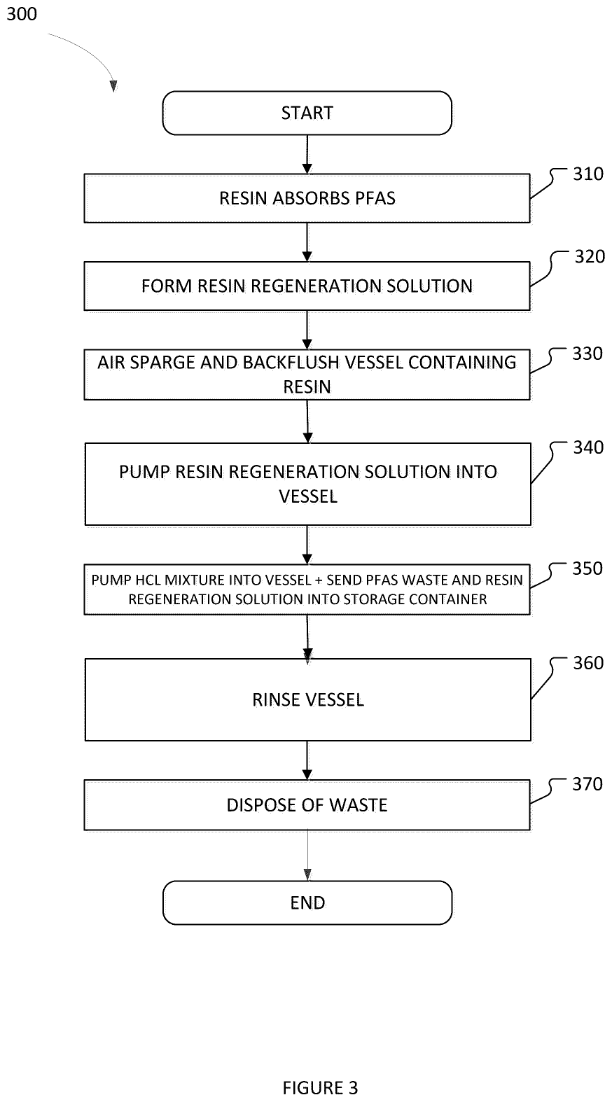

FIG. 3 depicts a method 300 for regenerating resin while stripping PFAS from the resin and disposing a resin regeneration solution, according to an embodiment. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

At operation 310, contaminated water my flow through a vessel including resin. Due to the resin's selectivity for PFAS, the resin by adsorb the PFAS, allowing the water to be filtered. In embodiments, the resin may be a WBA or SBA resin which be delivered in different forms such as free base form or Cl-form. Resins in free base form tend to react only with strong acids, but for PFAS the resins may be converted into Cl-form to increase the range of PFAS selectively, which may be done with a 2% strong acid solution. While the WBA may have a higher tendency to leak PFAS, they have a much higher capacity than strong base alternatives. Once the resin is loaded up to the designated breakthrough point with PFAS, the flowing water through the vessel may stop.

At operation 320, a resin regeneration solution may be formed. The resin regeneration solution may include equimolar ratios of a strong acid and a strong base to make the 10% salt (w/w) solution, as opposed to using mineral salt. This reaction may generate heat to make the brine hot. Subsequently, an extra 2-5% strong base (w/w) may be added to the solution.

At operation 330, the vessel with the resin may be air sparge and backflushed to get the beds as clean as possible and to get homogenization of resin beads.

At operation 340, the resin regeneration solution may be pumped into the vessel in either a co-current or counter-current flow until the vessel is full of regenerant. Once full, the resin may soak for a few hours, with air sparging of the vessel at predetermined intervals.

At operation 350, an strong acid mixture may be pumped into the vessel, such as two bed volumes with 2% HCl (w/w). The strong acid solution may be run in either a co-current or counter-current flow, stripping the resin of the PFAS, and sending the regen waste (including the PFAS) to the waste tank. This may put the resin into Cl-form.

At operation 360, the vessel may be rinsed in the normal flow direction until the pH of the beads stabilizes. This may require the bed volumes to be rinsed up to ten times. This volume can be reduced by using rinse water with a slightly elevated pH (around 8-8.5), and recirculating the rinse water, adjusting the pH to 8 before sending the rinse water back through the bed volumes.

At operation 370, the waste tank may be dosed with PAC to bind PFAS into solid waste, such as 5 g/L of PAC for a WBA regeneration cycle. The remaining brine may be blended into a discharge tank slowly. Alternatively, the liquid waste may be sent to a destruction technology to mineralize the PFAS compounds OR a compound and/or membrane filtration applied to recycle the caustic solution or the liquid may be disposed via other practical methods.

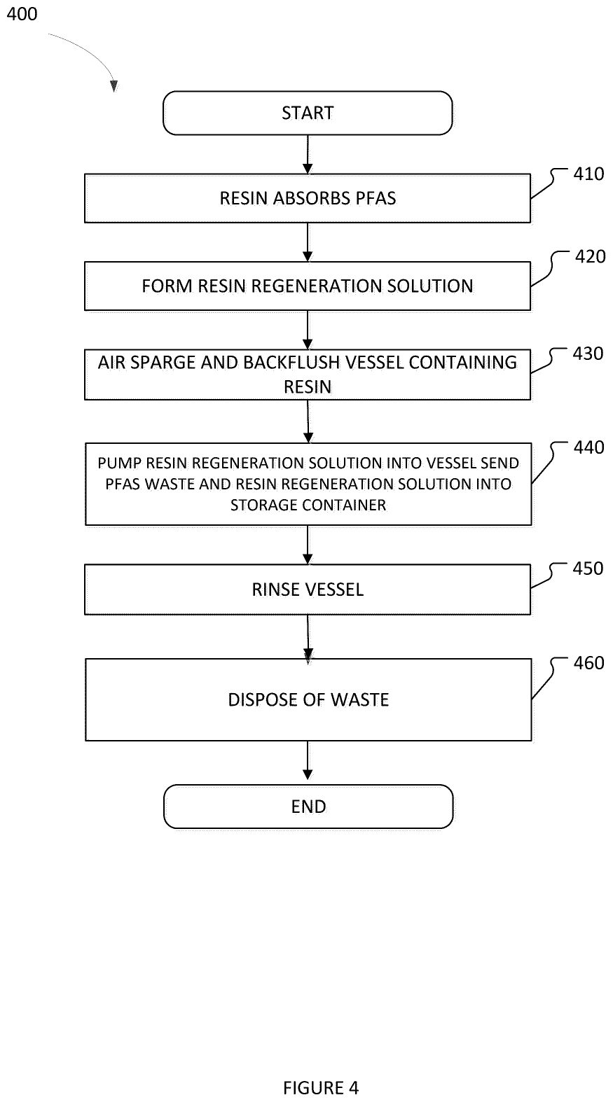

FIG. 4 depicts a method 400 for regenerating resin while stripping PFAS from the resin and disposing a resin regeneration solution, according to an embodiment. The operations of method 400 presented below are intended to be illustrative. In some embodiments, method 400 may be accomplished with one or more additional operations not described, and/or without one or more of the operations discussed. Additionally, the order in which the operations of method 400 are illustrated in FIG. 4 and described below is not intended to be limiting.

At operation 410, contaminated water my flow through a vessel including resin. Due to the resin's selectivity for PFAS, the resin may adsorb the PFAS, allowing the water to be filtered. In embodiments, the resin may be a SBA or WBA resin that most often delivered free base form or in Cl-form. SBAs may have a lower capacity for PFAS but are less likely to leak before reaching their full capacity, making them ideal for super ultra-trace applications. A lead bed of SBA may hold 80 mg of PFAS for every kg of resin (with 10% leakage).

At operation 420, a resin regeneration solution may be formed. The resin regeneration solution may include one or more salts at 5-10% (w/w) or equimolar ratios of a strong acid and a strong base to make the 5-10% salt (w/w). The later reaction may generate heat to make the brine hot. Subsequently, an extra 2-5% of strong acid (w/w) may be added to the solution. At operation 430, the vessel with the resin may be air sparged and backflushed to get the beds as clean as possible and to get homogenization of resin beads.

At operation 440, the resin regeneration solution may be pumped into the vessel in either a co-current or counter-current flow as slowly as possible with a variable speed drive pump, while the regen waste (including the PFAS) is sent to the waste tank. This may put the resin under osmotic shock, and will release nitrates and alkalinity, and the anions are replaced with Cl—.

At operation 450, the vessel may be rinsed in the normal flow direction until the pH of the beads stabilizes. This may require the bed volumes to be rinsed up to ten times. This volume can be reduced by using rinse water with a slightly elevated pH (around 8-8.5), and recirculating the rinse water, adjusting the pH to 8 before sending the rinse water back through the bed volumes.

At operation 460, the waste tank may be removed from the system.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A method for regenerating resin comprising:
flowing water contaminated with PFAS through a vessel that includes resin, the resin initially having an initial maximum capacity;
adsorbing the PFAS by resin within the vessel;
pumping resin regeneration solution into the vessel;
stripping the PFAS from the resin while the resin remains within the vessel;
sending the stripped PFAS into a waste tank, wherein the stripping of the PFAS from the resin restores the resin's adsorption capacity to at least 80% but less than 99% of its initial maximum capacity.

2. The method of claim 1, further comprising:
repeating the pumping, stripping and sending steps until a current maximum capacity of the resin is lower than 50% of the initial maximum capacity of the resin, the current maximum capacity being lower than the initial maximum capacity.

3. The method of claim 2, wherein the resin is used for multiple cycles without having to be replaced between cycles.

4. The method of claim 2, further comprising:
disposing of the resin when the current maximum capacity of the resin is lower than 50% of the initial maximum capacity of the resin.

5. The method of claim 1, wherein the resin regeneration solution does not include methanol or any other organic solvents.

6. The method of claim 1, wherein the resin is not removed from the vessel until the resin is disposed of.

7. The method of claim 1, wherein the resin regeneration solution includes a caustic solution.

8. The method of claim 1, wherein the resin regeneration solution includes brine with one or more salts at a concentration of 5-10% w/w.

9. The method of claim 1, wherein the resin is a weak base anion resin with a selectivity towards the PFAS.

10. The method of claim 1, further including:
backflushing the vessel after the PFAS is adsorbed by the resin.

11. The method of claim 10, wherein the resin regeneration solution is pumped into the vessel to send the stripped PFAS into the waste tank.

12. The method of claim 11, wherein the resin is put under osmotic shock to release all held anions, which are replaced by OH ions.

13. The method of claim 1, wherein the waste tank is configured to receive the resin regeneration solution, and the resin regeneration solution is disposed of.

14. The method of claim 1, wherein the resin regeneration solution is filtered through physical or chemical means.

15. The method of claim 14, wherein after the waste tank receives the resin regeneration solution and the stripped PFAS, the vessel is rinsed with rinse water, the rinse water having a pH of approximately 8-8.5.
